(19) United States
(12) Patent Application Publication
(10) Pub. No.: US 2024/0093715 A1
(43) Pub. Date: Mar. 21, 2024

(54) U-BOLT, CONSTRUCTION METHOD, AND DETECTION DEVICE

(71) Applicant: NIPPON TELEGRAPH AND TELEPHONE CORPORATION, Tokyo (JP)

(72) Inventors: Daiki KOBAYASHI, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/274,506

(22) PCT Filed: Jan. 29, 2021
(86) PCT No.: PCT/JP2021/003355

§ 371 Date: Jul. 27, 2023

(51) Int. Cl. F16B 35/00; F16L 3/02

(52) U.S. Cl. CPC F16B 35/00; F16L 3/02

(57) ABSTRACT

A U-bolt (10) according to the present disclosure is a U-bolt (10) including a pair of shaft parts (11) arranged in a first direction and extending in a second direction orthogonal to the first direction, and a bridge part (12) connecting one end of each of the pair of shaft parts (11) and in which a strain detection pattern is attached to at least a part of at least one shaft part (11) of the pair of shaft parts (11).

### TECHNICAL FIELD

The present disclosure relates to a U-bolt, a construction method, and a detection device.

### BACKGROUND ART

Conventionally, U-bolts have been used to fix a fastening object such as a pipe to a fastened object such as a frame or a wall surface. The U-bolt is a U-shaped bolt in which two linear shaft parts are connected by a bridge part. The shaft part of the U-bolt is inserted into each of two through-holes provided in the fastened object in a state of sandwiching the fastening object inside the U-bolt, and fastened from each end part of the two shaft parts by a nut, so that the fastening object can be sandwiched and fixed by the U-bolt and the fastened object.

When the fastening object is fixed to the fastened object by the U-bolt, it is necessary to fix the U-bolt perpendicularly to the fastened object. However, in many cases, the U-bolt is attached structurally in an inclined manner in terms of structure. When the U-bolt is attached in the inclined manner, the U-bolt may be a cause of breakage due to excessive stress.

A technique for providing a piezoelectric patch on a washer inserted into a bolt and measuring a fastening force of the bolt based on a pressure measured by the piezoelectric patch is described in NPL 1. In addition, a technique for embedding a piezoelectric sensor in a shaft part of a bolt and measuring a fastening force of the bolt on the basis of a strain of the shaft part of the bolt measured by the piezoelectric sensor is described in NPL 2.

### CITATION LIST

### Non Patent Literature

[NPL 1] H. Yin, T. Wang, D. Yang, S. Liu, J. Shao, and Y. Li, “A smart washer for bolt looseness monitoring based on piezoelectric active sensing method”, Appl. Sci., vol. 6, No. 11, 2016
[NPL 2] N. Shimoi, C. H. Cuadra, H. Madokoro, and M. Saijo, “Simple Smart Piezoelectric Bolt Sensor for Structural Monitoring of Bridges”, Int. J. Instrum. Sci., vol. 1, No. 5, pp. 78-83, 2013

### SUMMARY OF INVENTION

### Technical Problem

The technique described in the above-mentioned NPLs 1 and 2 is a technique for measuring the fastening force of a linear bolt, and a worker cannot confirm the fastening state of the shaft part of the U-bolt by a nut by this technique.

An object of the present disclosure, which has been made in view of the above-mentioned problems, is to provide a U-bolt, a construction method, and a detection device that enable the worker to confirm a state of fastening of the shaft part of the U-bolt by a nut.

### Solution to Problem

In order to solve the above problem, a U-bolt according to the present disclosure is a U-bolt including a pair of shaft parts which are arranged in a first direction, extending in a second direction orthogonal to the first direction, and fastened by a pair of nuts, and a bridge part connecting one end of each of the pair of shaft parts, and a strain detection pattern is attached on at least a part of at least one shaft part of the pair of shaft parts.

In addition, in order to solve the above problem, a construction method according to the present disclosure is a construction method for fastening a U-bolt including a pair of shaft parts which are arranged in a first direction, extending in a second direction orthogonal to the first direction, and fastened by a pair of nuts, and a bridge part connecting one end of each of the pair of shaft parts and in which a strain detection pattern is provided on at least a part of at least one shaft part of the pair of shaft parts to a fastened object and includes, by the detection device, a step of generating a first observation image by imaging a pattern region which is the at least part of the at least one shaft part to which the strain detection pattern is attached, a step of generating a second observation image by imaging the pattern region after fastening of the shaft part by the nut is adjusted, a step of detecting a strain of the pattern region on the basis of the first observation image and the second observation image, and a step of outputting fastening information related to fastening of the shaft part by the nut on the basis of the strain.

Further, in order to solve the above problem, a detection device according to the present disclosure is a detection device that detect a strain on a U-bolt including a pair of shaft parts which are arranged in a first direction, extending in a second direction orthogonal to the first direction, and fastened by a pair of nuts, and a bridge part connecting one end of each of the pair of shaft parts and in which a strain detection pattern is attached on at least a part of at least one shaft part of the pair of shaft parts and includes an imaging unit that generates a first observation image by imaging a pattern region which is the at least part of the at least one shaft part to which the strain detection pattern is attached and generates a second observation image by imaging the pattern region after the first observation image is generated and fastening of the shaft part by the nut is adjusted, a detection unit that detects a strain of the pattern region on the basis of the first observation image and the second observation image, and an output unit that outputs fastening information related to fastening of the shaft part by the nut on the basis of the strain.

### Advantageous Effects of Invention

According to a U-bolt, a construction method and a detection device according to the present disclosure, a worker can confirm a state of fastening of a shaft part of a U-bolt by a nut.

### BRIEF DESCRIPTION OF DRAWINGS

FIG. 1 is a diagram showing an example of a U-bolt according to a first embodiment.

FIG. 2 is a diagram showing another example of the U-bolt according to the first embodiment.

FIG. 3 is a diagram showing a modification example of the U-bolt shown in FIG. 1.

FIG. 4 is a diagram showing a modification example of the U-bolt shown in FIG. 2.

FIG. 5A is a diagram for explaining tensile force and compressive force acting on the U-bolt when axial force is uniform.

FIG. 5B is a diagram for explaining tensile force and compressive force acting on the U-bolt when axial force is non-uniform.

FIG. 6 is a diagram showing an example of a hardware configuration of a detection device according to the first embodiment.

FIG. 7 is a diagram showing an example of a functional configuration of the detection device according to the first embodiment.

FIG. 8 is a flowchart showing an example of operations of fastening the U-bolt to a fastened object according to the first embodiment.

FIG. 9 is a diagram showing an example of a functional configuration of the detection device according to a second embodiment.

FIG. 10 is a flowchart showing an example of operations of fastening the U-bolt to the fastened object according to the second embodiment.

### DESCRIPTION OF EMBODIMENTS

A description will be given below of embodiments of the present disclosure with reference to the drawings.

### First Embodiment

(Configuration of U-Bolt)

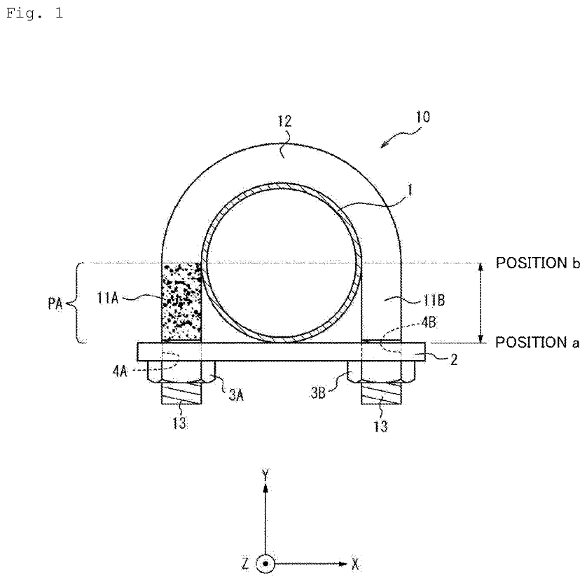

FIG. 1 is a diagram showing an example of a U-bolt 10 according to a first embodiment of the present disclosure.

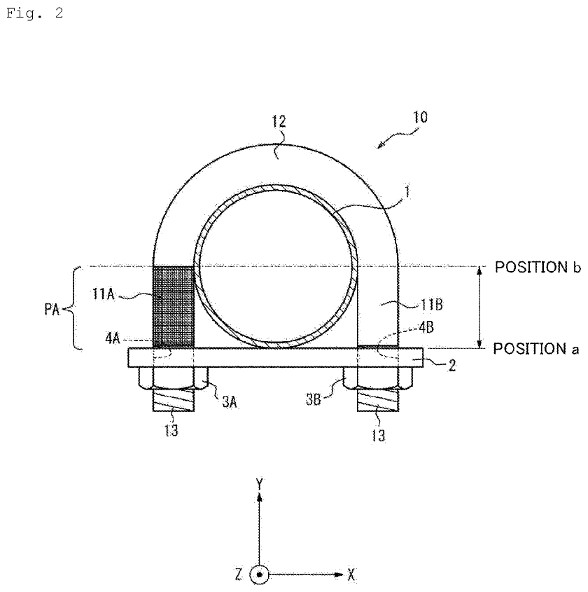

FIG. 2 is a diagram showing another example of the U-bolt 10 according to the first embodiment of the present disclosure.

As shown in FIGS. 1 and 2, the U-bolt 10 according to the first embodiment includes a pair of shaft parts 11A and 11B, and a bridge part 12.

The shaft part 11A and the shaft part 11B are arranged in a predetermined direction and extending in a direction orthogonal to the predetermined direction. Hereinafter, as shown in FIGS. 1 and 2, the direction in which the shaft part 11A and the shaft part 11B are arranged side by side is referred to as the X-axis direction (a first direction), the direction in which the shaft part 11A and the shaft part 11B extend is referred to as the Y-axis direction (a second direction), and the direction orthogonal to the X-axis direction and the Y-axis direction is referred to as the Z-axis direction (a third direction). In addition, when the shaft part 11A and the shaft part 11B are not distinguished from each other, the shaft parts 11A and the shaft part 11B are referred to as the shaft part 11. Further, In the following description, the shaft part 11A and the shaft part 11B are combined and referred to as a pair of shaft parts 11.

The bridge part 12 connects respective one ends of the shaft part 11a and the shaft part 11B. The bridge part 12 can be formed into a semi-circular curved shape, and the bridge part 12 connects one ends of the shaft part 11A and the shaft part 11B, respectively, so that the U-bolt 10 forms a U-shape. The shaft part 11A and the shaft part 11B have a screw part 13 having a screw thread structure on the other end side.

As shown in FIGS. 1 and 2, a fastening object 1 such as a pipe is arranged inside of a U-shaped U-bolt 10 (a space surrounded by a pair of shaft parts 11 and bridge part 12). In a state where the fastening object 1 is arranged inside, the shaft part 11A and the shaft part 11B are inserted from one surface side of the fastened object 2 into a pair of through-holes 4A and 4B provided in the fastened object 2 such as support hardware, respectively. By inserting the shaft part 11A and the shaft part 11B into the through-hole 4A and the through-hole 4B, the screw parts 13 of the shaft part 11A and the shaft part 11B are protruded to the other surface side of the fastened object 2. Nuts 3A and 3B having the screw thread structure screwed with the screw thread structure of the screw part 13 are fastened to the screw parts 13 of the shaft part 11A and the shaft part 11B protruding from the other surface side of the fastened object 2, respectively, and the shaft part 11 is fastened by the nut 3. Thus, the U-bolt 10 is fastened to the fastened object 2, and the fastening object 1 is sandwiched and fixed between the U-bolt 10 and the fastened object 2. Hereinafter, when no distinction is made between the nuts 3A and 3B, they are referred to as the nut 3. In addition, when the through-hole 4A and the through-hole 4B are not distinguished, they are called the through-hole 4.

At least a part of at least one shaft part 11 of the shaft part 11A and the shaft part 11B is provided with the strain detection pattern. Thereafter, at least a part of at least one shaft part 11 to which the strain detection pattern is attached is referred to as a “pattern region PA”.

In the examples shown in FIG. 1 and FIG. 2, the strain detecting pattern is attached to the whole of one shaft part 11A, but it is not limited thereto. For example, the strain detection pattern may be attached to a part of one shaft part 11A. Specifically, the strain detection pattern may be attached to a part of an outer edge of a cross section orthogonal to an axis of the shaft part 11, or may be attached to a part in a direction in which the axis of the shaft part 11 extends. The strain detection pattern is attached between a position of one surface of the fastened object 2 (a position a) and a position of a boundary of the shaft part 11 and the bridge part 12 (a position b) in a state where a pair of shaft parts 11A and 11B are inserted into a pair of through-holes 4A and 4B provided in the fastened object 2 respectively and the fastening object is sandwiched and fixed between the U-bolt 10 and one surface of the fastened object 2.

The strain detection pattern is a pattern applied to the member in an arbitrary method for detecting the strain ε of the member, and can be a speckle pattern as shown in FIG. 1 or a lattice pattern as shown in FIG. 2.

The speckle pattern may be, for example, a mottled pattern. It is preferable that a contrast of at least two colors constituting the speckle pattern is high, and more specifically, it is preferable that a difference between lightness, saturation, or hue of the two colors is higher than a predetermined threshold value. Thus, the strain ε of the shaft part 11A and the shaft part 11B can be detected with high accuracy by using the digital image correlation (DIC) method. For example, the two colors can be colors having high contrast of lightness such as white and black. In this case, the strain ε of the shaft part 11A and the shaft part 11B can be detected with high accuracy even in an environment such as an outdoor environment in which a measurement error tends to increase.

The speckle pattern can be easily obtained by applying two kinds of coating materials using a spray. For example, the speckle pattern may be formed by applying base coating with a white paint on the respective surfaces of the shaft part 11A and the shaft part 11B and applying a black pattern thereon.

The lattice interval of the lattice pattern may be arbitrary, but it is preferable to be about 1 mm. Thus, in the attaching of the U-bolt, the strain ε of the shaft part 11A and the shaft part 11B can be detected with high accuracy of about 0.01 mm which is 1/100 of 1 mm by using a sampling moire method.

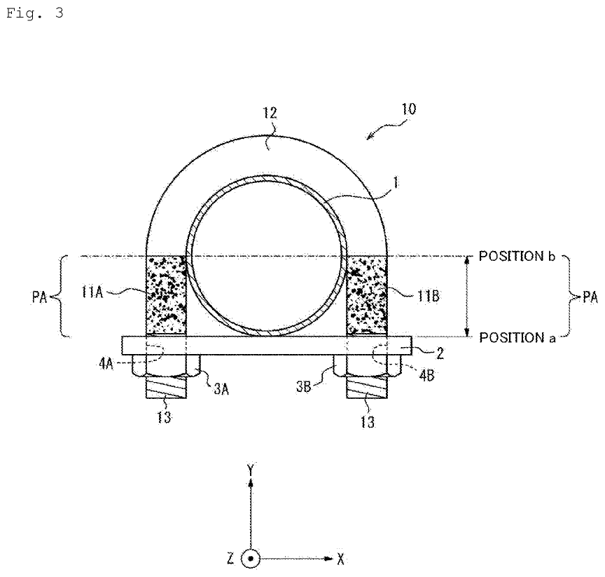

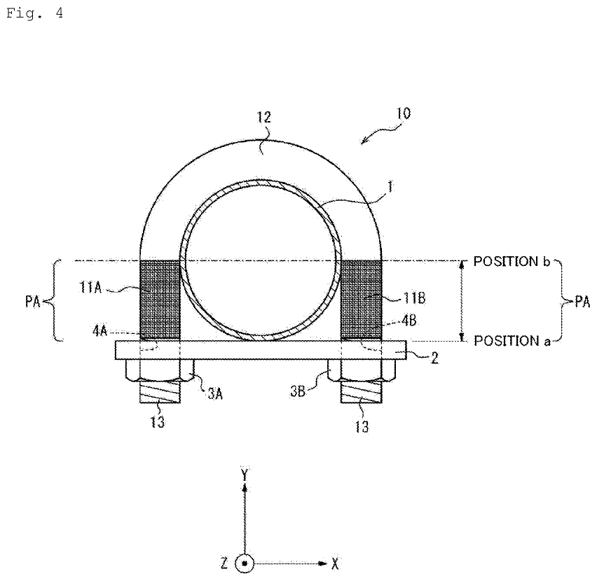

In the examples shown in FIGS. 1 and 2, the structure in which the strain detection pattern is applied only to the shaft part 11A has been described, but the present disclosure is not limited to this. For example, the strain detection pattern may be provided only on the shaft part 11B. Also, as shown in FIGS. 3 and 4, both the shaft part 11A and the shaft part 11B may be provided with the strain detection pattern. In the example shown in FIG. 3, the speckle pattern is attached to whole of both the shaft part 11A and the shaft part 11B. In the example shown in FIG. 4, the whole of both the shaft part 11A and the shaft part 11B is provided with the lattice pattern. Also, the strain detection pattern may be applied to each part of both the shaft part 11A and the shaft part 11B, and in such a constitution, it is preferable that the strain detection pattern applied to the shaft part 11A and the strain detection pattern applied to the shaft part 11B are positioned at the same height (at the same position in the Y-axis direction).

Thus, the strain detection pattern is applied to a part or whole of both the shaft part 11A and the shaft part 11B, so that the strain of each of the shaft part 11A and the shaft part 11B, that is, the difference of the axial force acting on each of the shaft part 11A and the shaft part 11B can be accurately detected.

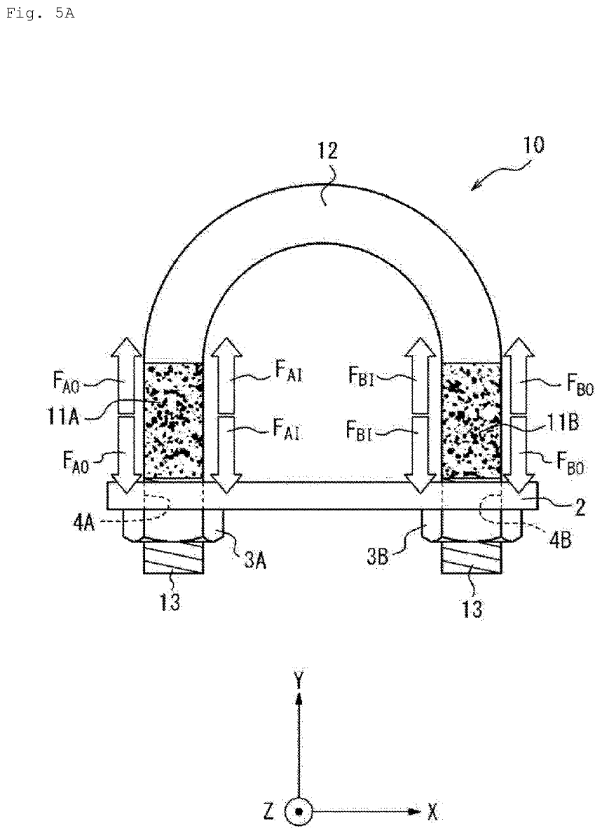

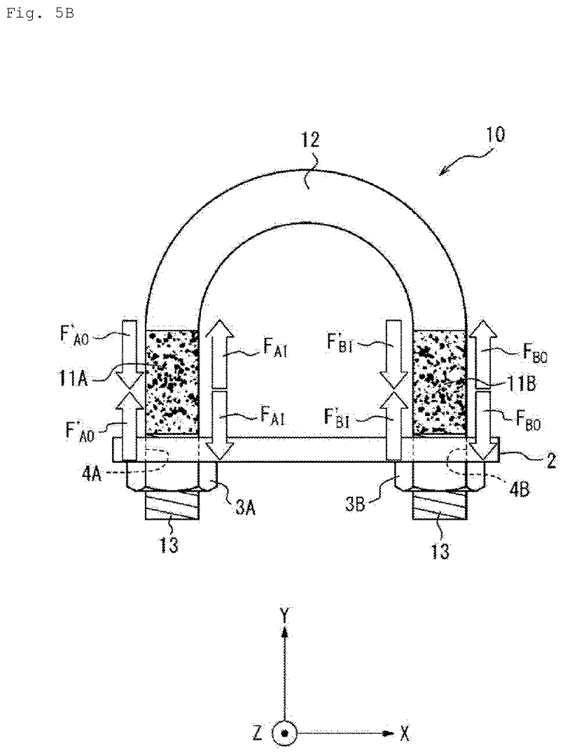

FIGS. 5A and 5B show tensile force and compressive force acting in a state where the U-bolt 10 shown in FIG. 3 is fastened to the fastened object 2. FIG. 5A shows the tensile force and compressive force acting on the U-bolt 10 when the axial force acting on the shaft part 11A and the shaft part 11B is uniform. FIG. 5B shows the tensile force and compressive force acting on the U-bolt 10 when the axial force acting on the shaft part 11A and the shaft part 11B is non-uniform. Note that, in FIGS. 5A and 5B, an example in which the strain detection pattern is the speckle pattern is shown, but the same is also applied to an example in which the strain detection pattern is the lattice pattern.

As shown in FIG. 5A, when the shaft part 11A and the shaft part 11B are uniformly fastened to the fastened object 2, the tensile forces F_{AO}, F_{AI}, F_{BO}, and F_{BI} of the same magnitude are respectively applied to the outside and inside of the shaft part 11A and the shaft part 11B. Therefore, the axial forces acting on the shaft part 11A and the shaft part 11B are substantially uniform. On the other hand, as shown in FIG. 5B, when the shaft part 11A and the shaft part 11B are non-uniformly fastened to the fastened object 2, the compression forces F′_{AO} and F′_{BI} are generated on the outside of the shaft part 11A and the inside of the shaft part 11B, respectively, and the tensile forces F_{AI} and F_{BO} are generated on the inside of the shaft part 11A and the outside of the shaft part 11B, respectively. Therefore, the axial force acting on the shaft part 11A and the shaft part 11B is non-uniform. In order to firmly fix the fastening object 1, it is necessary to make the axial force acting on the shaft part 11A and the shaft part 11B substantially uniform. Therefore, as described above, since the strain detection pattern is applied to both the shaft part 11A and the shaft part 11B and the strain ε is detected by using the pattern, the worker can confirm whether or not the axial force acting on the shaft part 11A and the shaft part 11B of the U-bolt 10 to the fastened object 2 is uniform. Thus, the worker can fasten the U-bolt 10 to the fastened object 2 appropriately by fastening the shaft part 11 by the nut 3 so that the axial force acting on the shaft part 11A and the shaft part 11B is uniform. Note that the tensile force and compressive force acting in a state where the U-bolt 10 shown in FIG. 4 is fastened to the fastened object 2 are the same.

(Hardware Configuration of Detection Device)

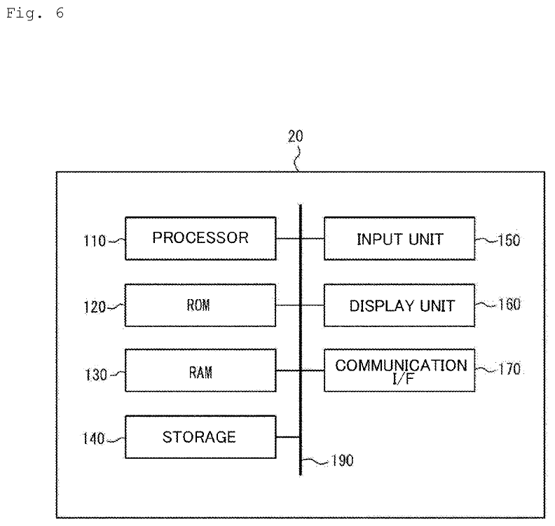

FIG. 6 is a diagram showing an example of a hardware configuration of the detection device 20 according to an embodiment of the present disclosure. FIG. 6 shows an example of the hardware configuration of the detection device 20 when the detection device 20 is constituted by a computer capable of executing a program instruction. The computer may be any of a general-purpose computer, a dedicated computer, a workstation, a PC (Personal Computer), an electronic note pad, a smartphone, or the like. The program instruction may be any of a program code, a code segment, or the like for executing a necessary task. When the detection device 20 is the smartphone, the worker can easily carry the detection device 20 to a place where the U-bolt 10 is fastened to the fastened object 2 in installation or inspection of the U-bolt 10, and convenience is improved.

As shown in FIG. 6, the detection device 20 includes a processor 110, a ROM (Read Only Memory) 120, a RAM (Random Access Memory) 130, a storage 140, an input unit 150, a display unit 160, and a communication interface (I/F) 170. The respective configurations are connected to each other via a bus 190 so as to be relatively communicable. Specifically, the processor 110 may be any of a CPU (Central Processing Unit), an MPU (Micro Processing Unit), a GPU (Graphics Processing Unit), a DSP (Digital Signal Processor), a SoC (System on a Chip), or the like, and may be constituted by a plurality of processors of the same kind or different kinds.

The processor 110 executes control of each configuration and various arithmetic processing. More specifically, the processor 110 reads a program from the ROM 120 or the storage 140 and executes the program using the RAM 130 as a working area. The processor 110 controls the respective configurations described above and performs various types of arithmetic processing in accordance with the program stored in the ROM 120 or the storage 140. In this embodiment, the program related to the present disclosure is stored in the ROM 120 or the storage 140.

The program may be provided by being stored on a non-transitory storage medium such as a CD-ROM (Compact Disk Read Only Memory), a DVD-ROM (Digital Versatile Disk Read Only Memory), or a USB (Universal Serial Bus) memory. In addition, the program may be downloaded from an external device over a network.

The ROM 120 stores various programs and various types of data. The RAM 130 is the working area and temporarily stores the program or data. The storage 140 is configured of a hard disk drive (HDD) or a solid state drive (SSD), and stores various programs including an operating system and various types of data.

The input unit 150 includes a pointing device such as a mouse and a keyboard, and is used to input various types of input.

The display unit 160 is a liquid crystal display, for example, and displays various information. By employing a touch panel system, the display unit 160 may also function as the input unit 150.

The communication I/F 170 is an interface for communicating with other equipment such as the external device (not shown) and, for example, a standard such as Ethernet (registered trademark), FDDI, Wi-Fi (registered trademark), or the like is used.

(Functional Configuration of Detection Device)

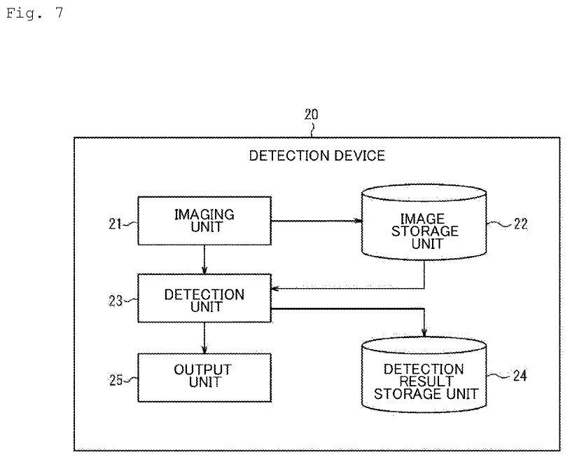

Next, the functional configuration of the detection device 20 according to the first embodiment will be described with reference to FIG. 7.

As shown in FIG. 7, the detection device 20 according to the present disclosure includes an imaging unit 21, an image storage unit 22, a detection unit 23, a detection result storage unit 24, and an output unit 25. The imaging unit 21 is constituted of a camera. The image storage unit 22 and the detection result storage unit 24 are constituted by, for example, a semiconductor memory, a magnetic memory, an optical memory, etc. The detection unit 23 constitutes a control unit (controller). The control unit may be constituted by dedicated hardware such as an ASIC (Application specific Integrated Circuit) and an FPGA (Field-Programmable Gate Array), or may be constituted by the processor, or may be constituted by including both. The output unit 25 may include, for example, the display unit 160.

The imaging unit 21 generates an observation image by imaging a pattern area PA being at least a part of at least one shaft part 11 to which the distortion detection pattern is attached.

More specifically, the region in which the image of the pattern region PA is shown in the observation image is hereinafter referred to as “observation region”.

The imaging unit 21 generates an observation image before adjustment (a first observation image) by imaging the pattern area PA being at least a part of at least one shaft part 11 to which the strain detection pattern is attached before adjustment of fastening of the shaft part 11 by the nut 3. The imaging unit 21 generates an observation image after adjustment (a second observation image) by imaging the pattern area PA being at least a part of at least one shaft part 11 to which the strain detection pattern is attached after adjustment of fastening of the shaft part 11 by the nut 3.

Here, “adjustment of fastening” means adjustment of a fastening degree of the shaft part 11 by the nut 3, and includes that after the shaft part 11 is inserted into the through-hole 4, the shaft part 11 is fastened by the nut 3 for the first time, and a fastening degree from a state where the shaft part 11 is already fastened by the nut 3 is changed.

The image storage unit 22 stores the observation image generated by the imaging unit 21. Specifically, the image storage unit 22 stores the observation image before adjustment. In addition, the image storage unit 22 may store the observation image after adjustment.

The detection unit 23 detects the strain ε of the pattern area PA on the basis of the observation image before adjustment and the observation image after adjustment. The detection unit 23 may detect the strain ε each time fastening of the shaft part 11 by the nut 3 is adjusted.

In a configuration in which the strain detection pattern is the speckle pattern, the detection unit 23 detects the strain ε of the pattern area PA using a digital image correlation method. Specifically, the detection unit 23 detects the strain ε of the pattern region PA on the basis of a difference between images of speckle patterns included in observation regions of the observation image before adjustment and the observation image after adjustment, respectively.

In one example, the observation image after adjustment in the k-th time (k is a natural number) is the observation image generated after the k-th time adjustment and before (k+1)-th time adjustment. The observation image before adjustment in the k-th time adjustment can be an initial observation image imaged when the fastening of the shaft part 11 by the nut 3 is not adjusted (that is, after the 0-th time adjustment and before the first time adjustment). In such a configuration, the detection unit 23 detects the strain ε on the basis of the initial observation image and the observation image after adjustment each time fastening of the shaft part 11 by the nut 3 is adjusted. Specifically, the detection unit 23 detects a change amount of the strain ε of the pattern area PA after the k-th adjustment with respect to the strain ε of the pattern area PA before the first adjustment, and thereby detects the strain ε.

In another example, similar to the above-described example, the observation image after adjustment in the k-th time adjustment is an observation image generated after the k-th time adjustment and before the (k+1)-th adjustment. The observation image before adjustment in the k-th time adjustment is, unlike the above-described example, an immediately before observation image generated before the k-th time adjustment and after the (k−1)-th time adjustment. In such a configuration, the detection unit 23 can detect the change amount of the strain ε of the pattern area PA generated by the k-th time adjustment with respect to the strain ε of the pattern area PA generated by the (k−1)-th time adjustment. In this case, each time fastening of the shaft part 11 by the nut 3 is adjusted, the detection unit 23 detects the strain ε on the basis of the immediately before observation image and the observation image after adjustment. Specifically, the detection unit 23 detects the change amount of the strain ε of the pattern area PA after k-th time adjustment with respect to the strain ε of the pattern area PA before k-th time adjustment and after (k−1)-th time adjustment. Then, the detection unit 23 detects the strain ε by summing up the change amounts in the first time to k-th time adjustments.

Note that the change amount of the strain ε with respect to the force acting on the U-bolt 10 differs depending on the material constituting the U-bolt 10. Then, the smaller the change amount of the strain ε with respect to the force acting on the U-bolt 10, the less the error is accumulated. In this case, the detection unit 23 can easily detect the strain ε by using the initial observation image as the observation image before adjustment. Further, as the change amount of the strain ε with respect to the force acting on the U-bolt 10 is larger, errors are accumulated, and it becomes difficult to detect the strain ε with high accuracy. Therefore, in this case, the strain ε can be detected by using the immediately before observation image generated immediately before the adjustment as the observation image before adjustment.

In principle, since the accuracy is regarded as important, it is preferable that the detection unit 23 detects the strain ε by using the initial observation image as the observation image before adjustment. However, in the U-bolt 10 in which large deformation exceeding 1% is generally generated, when the detection unit 23 uses the initial observation image as the observation image before adjustment, matching between the observation image before adjustment and the observation image after adjustment becomes difficult, and there is a case where a correct measurement result cannot be obtained. Therefore, in the U-bolt 10 in which a large deformation occurs as described above, the detection unit 23 uses the immediately before observation image as the observation image before adjustment, thereby preventing the matching from becoming difficult due to the large deformation. Note that, in this way, the accumulation of errors is increased by using the immediately before observation image as the observation image before adjustment by the detection unit 23. Therefore, whether the initial observation image or the immediately before observation image is used as the observation image before adjustment can be suitably designed depending on the easiness of deformation of the U-bolt 10.

Further, as the degree of fastening of the U-bolt 10 to the fastened object 2 becomes stronger, the change amount in the strain becomes larger. Therefore, it is more preferable that the detection unit 23 detects the strain ε by using the strength of fastening of the U-bolt 10 to the fastened object 2, that is, the observation image before adjustment corresponding to the magnitude of the target axial force acting on the U-bolt 10 (the target axial force). For example, the detection unit 23 may detect the strain ε by using the initial observation image as the observation image before adjustment when the target axial force is less than a predetermined value, and may detect the strain ε by using the immediately before observation image as the observation image before adjustment when the target axial force is equal to or more than the predetermined value.

In a configuration in which the strain detection pattern is the lattice pattern, the detection unit 23 detects the distortion ε of the pattern area PA using a sampling moire method. Specifically, the detection unit 23 detects the strain ε from the pattern area PA before adjustment of the pattern area PA after adjustment on the basis of the image of the lattice pattern included in each of observation areas of the observation image before adjustment and the observation image after adjustment. The observation image before adjustment used at this time is the same as the observation image before adjustment used in a configuration in which the strain detection pattern is the speckle pattern as described above.

The detection unit 23 can detect a target difference Δ ε₁ which is a difference between the strain ε and the target strain ε_{T}. In this case, the detection unit 23 can further detect whether or not the absolute value of the target difference Δ ε₁ is less than a predetermined threshold value. The target strain ε_{T} is a strain ε generated in the shaft part 11 on which the above-mentioned target axial force acts.

Also, when both shaft parts 11A and 11B are provided with the strain detection patterns and the observation images of both shaft parts 11A and 11B are generated by the imaging unit 21, the detection unit 23 can detect the strain ε_{A} and strain ε_{B} of both the shaft parts 11A and 11B on the basis of the image of the strain detection pattern included in the observation areas of both the shaft parts 11A and 11B.

In this case, the detection unit 23 can detect a target difference Δ ε_{1A} and a target difference Δ ε_{1B} which are differences from the strain ε_{A} and the strain ε_{B} and the target strain ε_{T} as the target difference Δ ε₁. In this case, the detection unit 23 can further detect whether or not the absolute values of the target difference Δ ε_{1A} and the target difference Δ ε_{1B} are less than the predetermined threshold value.

Further, the detection unit 23 can detect a relative difference Δ ε₂ which is a difference between the strain ε_{A} and the strain ε_{B}. In this case, the detection unit 23 can further detect whether or not the absolute value of the relative difference Δ ε₂ is less than the predetermined threshold value.

The detection unit 23 causes the output unit 25 to output fastening information related to fastening of the shaft part 11 of the U-bolt 10 by the nut 3 based on the strain ε. Further, the detection unit 23 stores the fastening information in the detection result storage unit 24.

The fastening information includes at least one of the strain ε, the target difference Δ ε₁, the target difference index, the relative difference Δ ε₂, the relative difference index, and the relative difference index. The target difference index is information indicating whether or not an absolute value of the target difference Δ ε₁ is less than the predetermined threshold value. The relative difference index is information indicating whether or not an absolute value of the relative difference Δ ε₂ is less than the predetermined threshold value.

When the detection unit 23 judges that the absolute value of the target difference Δ ε₁ is less than the predetermined threshold value, the fastening information may include information indicating that fastening of the U-bolt 10 is completed in place of the target difference index. When the detection unit 23 judges that the absolute value of the target difference Δ ε₁ is equal to or greater than the predetermined threshold value, the fastening information may include information indicating that fastening of the U-bolt 10 is not completed in place of the target difference index.

In addition, when the detection unit 23 judges that the absolute value of the relative difference Δ ε₂ is less than the predetermined threshold value, the fastening information may include information indicating that the shaft part 11A and the shaft part 11B are fastened substantially uniformly in place of the relative difference index. Further, when the detection unit 23 judges that the absolute value of the relative difference Δ ε₂ is equal to or more than the predetermined threshold value, the fastening information may include information indicating that the shaft part 11A and the shaft part 11B are not fastened substantially uniformly in place of the relative difference index.

The detection result storage unit 24 stores the fastening information detected by the detection unit 23. Thus, for example, evidence that the normal construction (the fastening of U-bolt 10) is completed can be left.

The output unit 25 outputs the fastening information related to fastening of the shaft part 11 of the U-bolt 10 by the nut 3 based on the strain ε detected by the detection unit 23.

(Construction Method for Attaching U-Bolt)

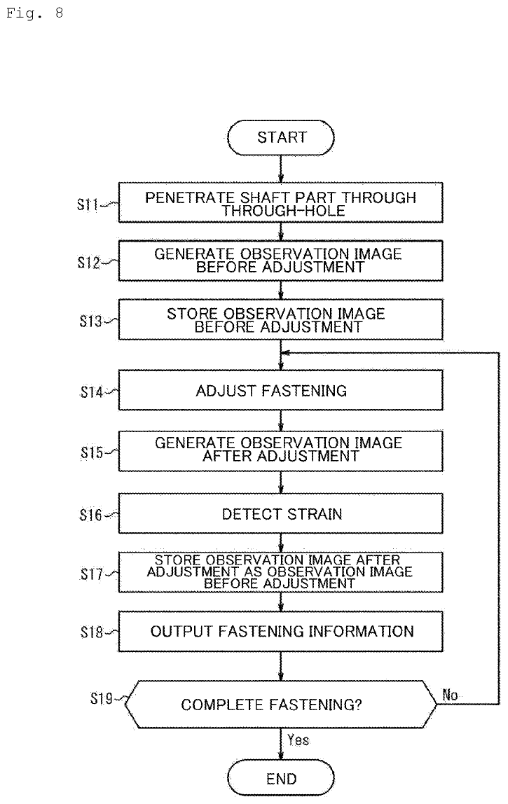

Next, an operation for fastening the U-bolt 10 according to the first embodiment will be described with reference to FIG. 8. FIG. 8 is a flowchart showing an example of the operation for fastening the U-bolt 10 according to the first embodiment. The operation for fastening the U-bolt 10 described with reference to FIG. 8 corresponds to the construction method for fastening the U-bolt 10 according to the first embodiment.

In a step S11, the worker penetrates the shaft part 11A and the shaft part 11B of the U-bolt 10 through the through-holes 4A and 4B, respectively.

In a step S12, the imaging unit 21 images the pattern area PA being at least a part of at least one shaft part 11 to which the strain detection pattern is attached, to generate the observation image before adjustment.

In a step S13, the image storage unit 22 stores the observation image before adjustment generated in the step S12.

In a step S14, the worker adjusts fastening of the shaft part 11 by the nut 3.

In a step S15, the imaging unit 21 images the pattern area PA after the fastening of the shaft part 11 by the nut 3 is adjusted, and thereby generates the observation image after adjustment.

In a step S16, the detection unit 23 detects the strain ε of the pattern area PA on the basis of the observation image before adjustment and the observation image after adjustment.

At this time, the detection unit 23 may detect the strain ε of one of the shaft part 11A and the shaft part 11B. The detection unit 23 may detect the strain ε of both the shaft part 11A and the shaft part 11B. The detection unit 23 may detect the target difference Δ ε₁ which is a difference between the strain ε and the target strain ε_{T}. It may be detected whether or not the absolute value of the target difference Δ ε₁ is less than the predetermined threshold value. The detection unit 23 may detect the relative difference Δ ε₂ when detecting the strain ε of both the shaft part 11A and the shaft part 11B. The detection unit 23 may judge whether or not the absolute value of the relative difference Δ ε₂ is less than the predetermined threshold value.

In a step S17, the image storage unit 22 stores the observation image after adjustment generated by the imaging unit 21 in the step S16 as the observation image before adjustment.

In a step S18, the output unit 25 outputs the fastening information detected by the detection unit 23.

In a step S19, the worker judges whether or not the fastening processing is completed on the basis of the fastening information.

At this time, when the strain ε included in the fastening information outputted in the step S18 is within a predetermined range from the target strain ε_{T}, the worker may judge that the fastening processing has been completed. In this case, when the strain ε is not within a predetermined range from the target strain ε_{T}, the worker judges that the fastening processing has not been completed.

Alternatively, when the absolute value of the target difference Δ ε₁ included in the fastening information outputted in the step S18 is less than the predetermined threshold value, the worker may judge that the fastening processing has been completed. In this case, when the absolute value of the target difference Δ ε₁ is equal to or greater than the predetermined threshold value, the worker may judge that the fastening process has not been completed.

Alternatively, when the target difference index included in the fastening information outputted in the step S18 indicates that the absolute value of the target difference Δ ε₁ is less than the predetermined threshold, it may be judged that the worker completes the fastening processing. In this case, when the target difference index indicates that the absolute value of the target difference Δ ε₁ is equal to or greater than the predetermined threshold value, it may be judged that the worker does not complete the fastening process.

In the step S19, when it is determined that the fastening processing has been completed, the fastening processing is terminated. In the step S19, when it is determined that the fastening processing has not been completed, the processing is returned to the step S14 and the processing is repeated.

In the repetition of the processing of the step S14 to the step S19, the worker may adjust the fastening of one of the shaft part 11A and the shaft part 11B or the fastening of both of the shaft part 11A and the shaft part 11B based on the fastening information. Further, the worker may adjust the fastening of the shaft part 11A or the shaft part 11B so that the relative difference Δ ε₂ becomes less than the predetermined threshold value, and then further adjust the fastening of the shaft part 11A and the shaft part 11B so that the target difference Δ ε₁ becomes small while maintaining a state in which the relative difference Δ ε₂ becomes less than the predetermined threshold value.

Note that, in the above description, the processing of the step S18 is performed after the processing of the step S17 is performed, but this is not limited thereto. For example, the processing of the step S17 may be performed after the processing of the step S18 is performed, or the processing of the step S17 and the processing of the step S18 may be performed at the same timing.

Also, the processing of S11 may be omitted. For example, when inspecting the U-bolt 10 already fastened to the fastened object 2, the operation for fastening is started from the processing of the step S12.

As described above, according to the first embodiment, at least a part of at least one shaft part 11 of the pair of shaft parts 11 is provided with the strain detection pattern. Thus, the shaft part 11 of the U-bolt 10 can be fastened by the nut 3 so that the strain ε of the shaft part 11 becomes the target strain ε_{T}, that is, the target axial force acts on the shaft part 11. Therefore, the worker can fasten the U-bolt 10 to the fastened object 2 with high accuracy, and the fastening object 1 can be firmly fixed accordingly.

Further, according to the first embodiment, the strain detection pattern is attached between one surface of the fastened object 2 and a boundary between the shaft part 11 and the bridge part 12 in one shaft part 11 in a state where the pair of shaft parts 11 are inserted into a pair of through-holes 4 provided in the fastened object 2 and the fastening object 1 is sandwiched and fixed between the U-bolt 10 and one surface of the fastened object 2. Thus, the worker can recognize the strain ε corresponding to the axial force acting on the shaft part 11 required for firmly fixing the fastening object 1 in attaching the U-bolt 10 to the fastened object 2, and can firmly fix the fastening object 1.

Further, in a state where the pair of shaft parts 11 are inserted into a pair of through-holes 4 provided in the fastened object 2 and the fastening object 1 is sandwiched and fixed by the U-bolt 10 and one surface of the fastened object 2, the strain detection patterns are attached between one surface of the fastened object 2 and the boundary between the shaft part 11 and the bridge part 12 in both the shaft parts 11. Thus, the worker can perform work so as not to increase the difference of strain detected by using the strain detecting patterns attached to the shaft part 11A and the shaft part 11B, respectively, in attaching the U-bolt 10 to the fastened object 2. Therefore, the worker can fasten the shaft part 11 of the U-bolt 10 by the nut 3. Accordingly, the worker can properly fasten the U-bolt 10 to the fastened object 2, and can firmly fix the fastening object 1.

According to the first embodiment, the detection device 20 outputs fastening information based on the target difference Δ ε₁. Therefore, the worker can fasten the shaft part 11 of the U-bolt 10 by the nut 3 so that the strain ε generated in the U-bolt 10 becomes the target strain ε_{T}, that is, so that the target axial force acts on the U-bolt 10, accordingly, the fastening object 1 can be firmly fixed.

In addition, according to the first embodiment, the detection device 20 outputs the fastening information based on the relative difference Δ ε₂. In fastening the shaft part 11 of the U-bolt 10 by the nut 3, it is necessary to maintain a state in which the strain ε_{A} of the shaft part 11A and the strain ε_{B} of the shaft part 11B are substantially the same not only when fastening is completed but also in the middle of work until fastening is completed. Therefore, the worker is required not only to set the strain ε_{A} and the strain ε_{B} as the target strain ε_{T}, but also to set the relative difference Δ ε₂, which is the difference between the strain ε_{A} and the strain ε_{B}, to be small during the work. Therefore, as described above, when the detection device 20 outputs the fastening information based on the relative difference Δ ε₂, the worker can recognize the relative difference Δ ε₂, and fasten properly the shaft part 11 of the U-bolt 10 to the nut 3 on the basis of this. Thus, the worker can firmly fix the fastening object 1.

### Second Embodiment

(Configuration of U-Bolt)

A U-bolt 10 according to a second embodiment of the present disclosure is similar to the U-bolt 10 according to the first embodiment.

(Hardware Configuration of Detection Device)

The hardware configuration of the detection device 20A according to the second embodiment is similar to that of the detection device 20 according to the first embodiment.

(Functional Configuration of Detection Device)

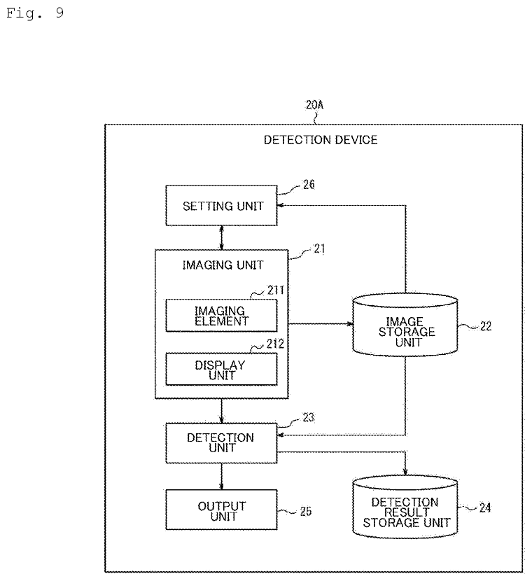

Next, the functional configuration of the detection device 20A according to the second embodiment will be described with reference to FIG. 9. The detection device 20A includes an imaging unit 21, an image storage unit 22, a detection unit 23, a detection result storage unit 24, an output unit 25, and a setting unit 26. The image storage unit 22, the detection unit 23, the detection result storage unit 24, and the output unit 25 according to the second embodiment are similar to each of the image storage unit 22, the detection unit 23, the detection result storage unit 24, and the output unit 25 according to the first embodiment.

The imaging unit 21 according to the second embodiment is configured of the camera similarly to the imaging unit 21 according to the first embodiment. Specifically, the imaging unit 21 includes an imaging element 211 for forming an image of a subject, and a display unit 212 for displaying the image.

The setting unit 26 constitutes a control unit (a controller). The setting unit 26 causes the display unit 212 to display an image obtained by superimposing the observation image before adjustment stored in the image storage unit 22 on the image of the subject formed by the imaging element 211.

The imaging unit 21 according to the second embodiment is configured of the camera similarly to the imaging unit 21 according to the first embodiment. The imaging unit 21 generates the observation image after adjustment by imaging the pattern area PA existing in the real space at an angle of view such that an image of the pattern area PA in the observation image before adjustment displayed on the display unit 212 by the setting unit 26 substantially coincides with the pattern area PA existing in the real space after the fastening is adjusted.

In one example, the worker judges whether or not the image of the pattern area PA in the observation image before adjustment substantially coincides with the pattern area PA existing in the real space after adjustment of fastening. In such a configuration, the worker operates the detection device 20A when it is judged that the image of the pattern area PA in the observation image before adjustment substantially coincides with the pattern area PA existing in the real space. Then, the setting unit 26 acquires an angle of view of the imaging unit 21 on the basis of an operation by the worker, and controls the imaging unit 21 to perform imaging at the angle of view. “The image of the pattern area PA in the observation image before adjustment substantially coincides with the pattern area PA existing in the real space” means that the area of an area where the image of the pattern area PA does not overlap the pattern area PA existing in the real space is equal to or less than a predetermined ratio to the area of the image of the pattern area PA.

In another example, the setting unit 26 judges whether or not the image of the pattern area PA in the observation image before adjustment substantially coincides with the pattern area PA existing in the real space after adjustment of fastening by an arbitrary image processing method. In such a configuration, the setting unit 26 acquires the angle of view of the imaging unit 21 when it is judged that the image of the pattern area PA in the observation image before adjustment substantially matches the pattern area PA existing in the real space, and controls the imaging unit 21 to image at the angle of view.

(Construction Method for Attaching U-Bolt)

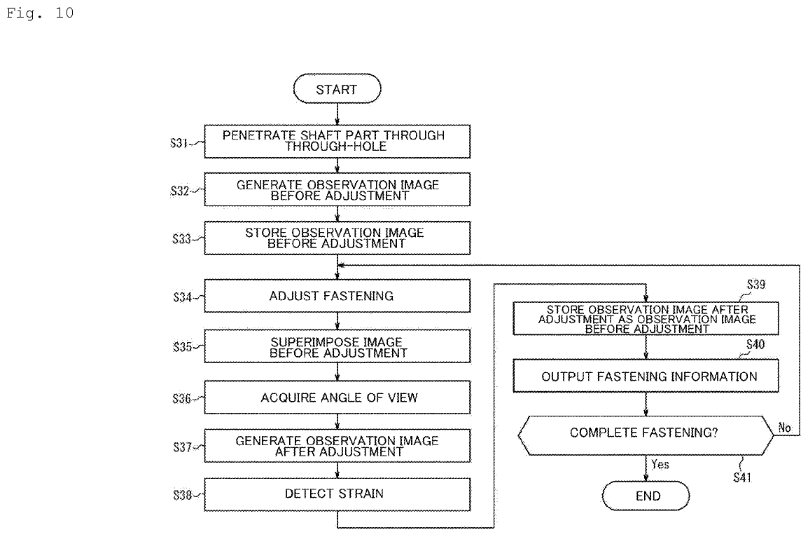

Next, an operation for fastening the U-bolt 10 according to the second embodiment will be described with reference to FIG. 10. FIG. 10 is a flowchart showing an example of an operation for fastening the U-bolt 10 according to the second embodiment. The operation for fastening the U-bolt 10 described with reference to FIG. 10 corresponds to the construction method for fastening the U-bolt 10 according to the second embodiment.

First, processing from a step S31 to a step S34 is performed. The processing from the step S31 to the step S34 is similar to the processing from the step S11 to the S14 according to the first embodiment.

In a step S35, the setting unit 26 superimposes the observation image before adjustment on the imaging range of the imaging unit 21.

In a step S36, a setting unit 26 acquires the angle of view so that the image of the pattern area PA in the observation image before adjustment displayed in the imaging range substantially coincides with the pattern area PA existing in the real space after the fastening is adjusted.

In a step S37, the imaging unit 21 images the pattern area PA existing in the real space at the angle of view acquired in the step S36 to generate the observation image after adjustment.

Subsequently, processing from a step S38 to a step S41 is performed. The processing from the step S38 to the step S41 is similar to the processing from the step S16 to the S19 according to the first embodiment.

As described above, according to the second embodiment, the imaging unit 21 can generate the observation image after adjustment having the same angle of view as that of the observation image before adjustment. Therefore, the detection unit 23 can detect the strain ε of the shaft part 11 by using the observation image before adjustment and the observation image after adjustment having the same angle of view. Therefore, the detection unit 23 can detect the strain ε more accurately than when detecting the strain ε of the shaft part 11 by using the observation image before adjustment and the observation image after adjustment generated by being imaged at mutually different angle of view. Further, since the detection unit 23 can detect the strain without correcting the observation area in the observation image before adjustment and the observation image after adjustment generated by being imaged at mutually different angle of view, the processing load can be reduced.

<Program>

A computer can be suitably used to function as the units of the detection device 20 or the detection device 20A described above. Such a computer can be realized by storing the program describing the details of processing realizing the functions of the detection device 20 in a storage unit of the computer and allowing a processor of the computer to read and execute the program. That is, the program can cause the computer to function as the above-described detection device 20 or the detection device 20A. Further, the program can be stored in a non-temporary storage medium. In addition, the program may also be provided via a network.

While one embodiment has been described above as a typical example, it is clear for a person skilled in the art that many alterations and substitutions are possible without departing from the subject matter and scope of the present disclosure. Therefore, the embodiment described above should not be interpreted as limiting and the present invention can be modified and altered in various ways without departing from the scope of the claims. For example, a plurality of configuration blocks shown in the configuration diagram of the embodiment may be combined to one, or one configuration block may be divided.

### REFERENCE SIGNS LIST

1 Fastening object
2 Fastened object
3, 3A, 3B Nut
4, 4A, 4B Through-hole
10 U-bolt
11, 11A, 11B Shaft part
12 Bridge part
13 Screw part
20, 20A Detection device
21 Imaging unit
22 Image storage unit
23 Detection unit
24 Detection result storage unit
25 Output unit
26 Setting unit
110 Processor
120 ROM
130 RAM
140 Storage
150 Input unit
160 Display unit
170 Communication I/F
190 Bus
211 Imaging element
212 Display unit

1. A U-bolt, comprising:
a pair of shaft parts, the pair of shaft parts is placed in a first direction and extending in a second direction orthogonal to the first direction, and
a bridge part connecting one end of each of the pair of shaft parts, wherein a strain detection pattern is attached on at least a part of at least one shaft part of the pair of shaft parts.

2. The U-bolt according to claim 1, wherein
the strain detection pattern is attached between one surface of a fastened object and a boundary between the shaft part and the bridge part in the at least one shaft part in a state where the pair of shaft parts are inserted into a pair of through-holes provided in the fastened object and a fastening object is sandwiched and fixed by the U-bolt and one surface of the fastened object.

3. The U-bolt according to claim 1, wherein
the strain detection pattern is a speckle pattern.

4. A construction method for fastening a U-bolt, the method comprising:
generating a first observation image by imaging a pattern region which is at least a part of the at least one shaft part to which a strain detection pattern is attached, wherein the U-bolt comprises a pair of shaft parts placed in a first direction, extending in a second direction orthogonal to the first direction, and fastened by a pair of nuts, and a bridge part connecting one end of each of the pair of shaft parts and in which the strain detection pattern is attached on at least a part of at least one shaft part of the pair of shaft parts to a fastened object;
generating a second observation image by imaging the pattern region after fastening of the shaft part by a nut of the pair of nuts is adjusted;
detecting a strain of the pattern region on the basis of the first observation image and the second observation image; and
outputting fastening information related to fastening of the shaft part by the nut on the basis of the strain.

5. The construction method according to claim 4, comprising:
displaying an image, wherein the image is obtained by superimposing the first observation image on an image of a subject formed by an imaging element; and
generating the second observation image by imaging a pattern region existing in a real space at an angle of view such that an image of the pattern region in the first observation image displayed on a display substantially coincides with the pattern region existing in the real space after adjusting the fastening using the U-bolt.

6. A detection device that detect a strain on a U-bolt, comprising a processor configured to execute operations comprising:
generating a first observation image by imaging a pattern region which is at least a part of at least one shaft part to which a strain detection pattern is attached and generate a second observation image by imaging the pattern region after the first observation image is generated and fastening of the at least one shaft part by a nut is adjusted, wherein the U-bolt comprises a pair of shaft parts placed in a first direction, extending in a second direction orthogonal to the first direction, and fastened by a pair of nuts, and a bridge part connecting one end of each of the pair of shaft parts and in which the strain detection pattern is attached on at least the part of the at least one shaft part of the pair of shaft parts;
detecting a strain of the pattern region on the basis of the first observation image and the second observation image; and
outputting fastening information related to fastening of the shaft part by the nut on the basis of the strain.

7. The detection device according to claim 6, wherein,
the generating the first observation image further comprises an imaging element that forms an image of a subject and displaying an image on a display,
the processor further configured to execute operations comprising:
causing to display an image obtained by superimposing the first observation image on the image of the subject formed by the imaging element, and
wherein the generating the first observation image further comprises generating the second observation image by imaging a pattern area existing in the real space at an angle of view, and the image of the pattern area in the first observation image displayed substantially coincides with the pattern area existing in the real space after adjusting the fastening.

8. The U-bolt according to claim 1, wherein
the strain detection pattern includes a lattice pattern.

9. The U-bolt according to claim 1, wherein the U-bolt fixes a fastening object to a fastened object using a nut.

10. The U-bolt according to claim 1, wherein the strain detection pattern enables the U-bolt fixing a fastening object in balance by fastening without increasing a difference of strain between the strain detection pattern and another strain detection pattern attached to the U-bolt.

11. The U-bolt according to claim 2, wherein
the strain detection pattern is a speckle pattern or a lattice pattern.

12. The construction method according to claim 4, wherein the strain detection pattern is attached between one surface of a fastened object and a boundary between the shaft part and the bridge part in the at least one shaft part in a state where the pair of shaft parts are inserted into a pair of through-holes provided in the fastened object and a fastening object is sandwiched and fixed by the U-bolt and one surface of the fastened object.

13. The construction method according to claim 4, wherein the strain detection pattern includes a speckle pattern.

14. The construction method according to claim 4, wherein the strain detection pattern includes a lattice pattern.

15. The construction method according to claim 4,
wherein the strain detection pattern enables the U-bolt fixing a fastening object in balance by fastening without increasing a difference of strain between the strain detection pattern and another strain detection pattern attached to the U-bolt.

16. The construction method according to claim 12, wherein the strain detection pattern is a speckle pattern or a lattice pattern.

17. The detection device according to claim 6, wherein the strain detection pattern is attached between one surface of a fastened object and a boundary between the shaft part and the bridge part in the at least one shaft part in a state where the pair of shaft parts are inserted into a pair of through-holes provided in the fastened object and a fastening object is sandwiched and fixed by the U-bolt and one surface of the fastened object.

18. The detection device according to claim 6, wherein the strain detection pattern includes a speckle pattern.

19. The detection device according to claim 6, wherein the strain detection pattern includes a lattice pattern.

20. The detection device according to claim 6, wherein the strain detection pattern enables the U-bolt fixing a fastening object in balance by fastening without increasing a difference of strain between the strain detection pattern and another strain detection pattern attached to the U-bolt.
